(19) United States
(12) Patent Application Publication
(10) Pub. No.: US 2024/0186673 A1
(43) Pub. Date: Jun. 6, 2024

(54) RECONFIGURABLE COUPLER BASED ON RIDGE GAP WAVEGUIDE

(71) Applicant: Nanjing University of Posts and Telecommunications, Nanjing (CN)

(72) Inventors: Feng XU, Nanjing (CN); Yali ZHANG, Nanjing (CN)

(73) Assignee: Nanjing University of Posts and Telecommunications, Nanjing (CN)

(21) Appl. No.: 18/527,418

(22) Filed: Dec. 4, 2023

(30) Foreign Application Priority Data
Dec. 6, 2022 (CN) 202211555696 .5

(51) Int. Cl. H01P 5/107; H01P 1/15

(52) U.S. Cl. CPC H01P 5/107; H01P 1/15

(57) ABSTRACT

A reconfigurable coupler based on a ridge gap waveguide. The reconfigurable coupler includes an inverted microstrip line, a ridge gap waveguide, and several reconfiguration components configured to adjust a coupling degree of a coupler, where the inverted microstrip line feeds the ridge gap waveguide with power, the inverted microstrip line is located at an upper layer while the ridge gap waveguide is located at a lower layer, the ridge gap waveguide includes an upper metal layer, a second dielectric layer and a lower metal layer that are arranged from top to bottom, the upper metal layer is in a square shape having a gap at a diagonal, four sides of the upper metal layer are provided with microstrip lines extending outward to the inverted microstrip line respectively, two sides of the gap are each provided with several isolation grooves, and the reconstruction components are arranged at the isolation grooves.

### CROSS REFERENCE TO RELATED APPLICATION

This application is based upon and claims foreign priority to Chinese Patent Application No. 202211555696.5, filed on Dec. 6, 2022, the entire content of which is incorporated herein by reference.

### TECHNICAL FIELD

The present invention relates to a reconfigurable coupler based on a ridge gap waveguide, and belongs to technical field of communication.

### BACKGROUND

As the new-generation 5G communication system is gradually commercialized and deployed, microwave and millimeter wave communication technologies are also developing rapidly. The development of communication technologies has been boosted by people's demands for high-quality wireless communication. At present, low-frequency spectrum resources can no longer satisfy the increasing size of data transmitted in mobile communication. Therefore, a high-frequency band development trend of new-generation wireless communication systems is the inevitable, in which submillimeter wave and millimeter wave bands are involved.

A traditional waveguide structure is no longer suitable for use in the high-frequency band. A gap waveguide is very applicable to a design of a high-frequency radio frequency device because of its advantages of low transmission loss, large power capacity, low machining and assembly difficulty, and easy integration. The radio frequency device is an indispensable basic component in a wireless communication system. Its technological innovation is of great significance for improvement in performance of a communication system.

Various coupler designs based on a ridge gap waveguide have emerged and showed excellent performance in the prior art. However, none of these designs has reconfigurable performance, which greatly limits development of the couplers based on a ridge gap waveguide. Therefore, it is important to study a reconfigurable coupler based on a ridge gap waveguide.

The above problems need to be considered and solved in design and production processes of the reconfigurable coupler based on a ridge gap waveguide.

### SUMMARY

An objective of the present invention is to provide a reconfigurable coupler based on a ridge gap waveguide, so as to solve problems that an existing coupler based on a ridge gap waveguide in the prior art has no reconfigurable performance and can hardly adjust a coupling degree of a coupler quickly.

In the technical solution of the present invention:

A reconfigurable coupler based on a ridge gap waveguide includes an inverted microstrip line, a ridge gap waveguide, and several reconfiguration components configured to adjust a coupling degree of a coupler. The inverted microstrip line feeds the ridge gap waveguide with power. The inverted microstrip line is located at an upper layer while the ridge gap waveguide is located at a lower layer. The ridge gap waveguide includes an upper metal layer, a second dielectric layer and a lower metal layer that are arranged from top to bottom. The upper metal layer is in a square shape having a gap at a diagonal. Four sides of the upper metal layer are provided with microstrip lines extending outward to the inverted microstrip line respectively. Two sides of the gap are each provided with several isolation grooves. The reconstruction components are arranged at the isolation grooves, and the reconstruction components are connected to the upper metal layer and the lower metal layer separately.

Further, the reconfiguration component includes a capacitor, a metal through hole for reconfiguration, a divided-square-shaped groove, and a PIN diode. The isolation groove is internally provided with the capacitor. The lower metal layer is provided with the divided-square-shaped groove and the PIN diode. The PIN diode is arranged in the middle of the divided-square-shaped groove. Two ends of the PIN diode are connected to the metal through holes for reconfiguration respectively. The metal through holes for reconfiguration are connected to groove walls of the isolation grooves on two sides of the gap by means of the capacitors respectively.

Further, the divided-square-shaped groove includes an outer rectangular-ring-shaped groove and an inner strip-shaped groove. The inner strip-shaped groove is provided in the outer rectangular-ring-shaped groove, and two ends of the inner strip-shaped groove are connected to two sides of the outer rectangular-ring-shaped groove respectively. The PIN diode is arranged in the inner strip-shaped groove.

Further, the inverted microstrip line includes a top metal layer, a first dielectric layer having a hollowed middle part and four metal strips distributed on four sides of the first dielectric layer that are arranged from top to bottom. The first dielectric layer is in a square-ring shape larger than the ridge gap waveguide. A middle portion of the first dielectric layer is provided with an air cavity.

Further, the second dielectric layer is provided with a mushroom-shaped electromagnetic gap structure periodically arranged, that is, a mushroom-shaped electromagnetic band gap (EBG) structure. The mushroom-shaped EBG structure includes metal through holes I and circular metal sheets. Ends of the metal through holes I are provided with the circular metal sheets. The metal through holes I and the circular metal sheets are combined and arranged periodically. Two ends of the mushroom-shaped EBG structure are connected to the air cavity and the lower metal layer respectively.

Further, the upper metal layer and the metal strips are arranged on the same level, and the upper metal layer is located in a center of the inverted microstrip line.

Further, the second dielectric layer is provided with several metal through holes II. One ends of the metal through holes II are connected to the lower metal layer, and the other ends of the metal through holes II are connected to the microstrip lines and/or the upper metal layer.

Further, two ends of the diagonal of the upper metal layer are provided with metal through holes for adjustment respectively. Two ends of the metal through holes for adjustment are connected to the upper metal layer and the lower metal layer respectively. The metal through holes for adjustment and the gap are provided at different diagonals of the upper metal layer respectively.

Further, the reconfigurable coupler based on a ridge gap waveguide adjusts the coupling degree before machining and manufacturing through setting of a size of the metal through holes for adjustment and/or a size of the upper metal layer, and a distance of the gap.

Further, a reconfiguration process of the reconfigurable coupler based on a ridge gap waveguide is as follows: the metal through holes for reconfiguration of the reconfiguration components are connected to the upper metal layer and the lower metal layer of the ridge gap waveguide separately, such that a coupling degree adjustment parameter of a distance of the gap of the upper metal layer is converted to the lower metal layer; and further the PIN diode loaded on the lower metal layer is controlled to be switched on and off, such that the coupling degree of the coupler is adjusted after machining and manufacturing.

The present invention has the following beneficial effects: the reconfigurable coupler based on a ridge gap waveguide can quickly and simply adjust the coupling degree of the coupler according to an on-off state of the PIN diode loaded on the lower metal layer of the ridge gap waveguide, such that the coupler has reconfigurable performance, a size of the coupler does not need to be changed, and demands of easy integration and simple machining can be satisfied while a reconfigurable function is achieved.

### BRIEF DESCRIPTION OF THE DRAWINGS

FIG. 1 is a schematic structural diagram of an explosive view of a reconfigurable coupler based on a ridge gap waveguide according to an example of the present invention;

FIG. 2 is a schematic structural diagram of a side view of a reconfigurable coupler based on a ridge gap waveguide according to an example of the present invention;

FIG. 3 is a schematic structural diagram of a ridge gap waveguide and a reconfiguration component according to an example;

FIG. 4 is a schematic structural diagram of a reconfiguration component according to an example;

FIG. 5 is a schematic structural diagram of a first dielectric layer, metal strips and an air cavity of an inverted microstrip line according to an example;

FIG. 6 is a schematic diagram of simulation S parameters of a reconfigurable coupler based on a ridge gap waveguide under the condition that 4 PIN diodes are all switched off according to an example;

FIG. 7 is a schematic diagram of simulation S parameters of a reconfigurable coupler based on a ridge gap waveguide under the condition that two PIN diodes in the middle are switched on and two PIN diodes at sides are switched off according to an example;

FIG. 8 is a schematic diagram of simulation S parameters of a reconfigurable coupler based on a ridge gap waveguide under the condition that two PIN diodes in the middle are switched off and two PIN diodes at sides are switched on according to an example; and

FIG. 9 is a schematic diagram of simulation S parameters of a reconfigurable coupler based on a ridge gap waveguide under the condition that 4 PIN diodes are all switched on according to an example.

In the figures: 1—inverted microstrip line, 2—ridge gap waveguide, 3—reconfiguration component, and 4—metal through hole for adjustment;
11—top metal layer, 12—first dielectric layer, 13—metal strip, and 14—air cavity;
21—upper metal layer, 22—second dielectric layer, 23—lower metal layer, 24—gap, 25—microstrip line, 26—isolation groove, 27—metal through hole I, 28—circular metal sheet, and 29—metal through hole II;
31—capacitor, 32—metal through hole for reconfiguration, 33—divided-square-shaped groove, and 34—PIN diode; and
331—outer rectangular-ring-shaped groove, and 332—inner strip-shaped groove.

### DETAILED DESCRIPTION OF THE EMBODIMENTS

Preferred examples of the present invention will be described in detail below in conjunction with accompanying drawings. Example:

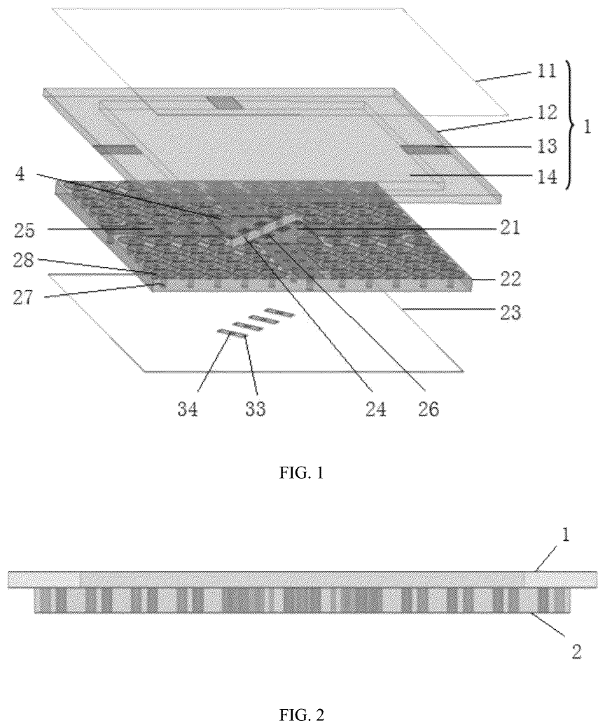

As shown in FIGS. 1 and 2, a reconfigurable coupler based on a ridge gap waveguide includes an inverted microstrip line 1, a ridge gap waveguide 2, and several reconfiguration components 3 configured to adjust a coupling degree of a coupler. The inverted microstrip line 1 feeds the ridge gap waveguide 2 with power. The inverted microstrip line 1 is located at an upper layer while the ridge gap waveguide 2 is located at a lower layer. The ridge gap waveguide 2 includes an upper metal layer 21, a second dielectric layer 22 and a lower metal layer 23 that are arranged from top to bottom. The upper metal layer 21 is in a square shape having a gap 24 at a diagonal. Four sides of the upper metal layer 21 are provided with microstrip lines 25 extending outward to the inverted microstrip line 1 respectively. Two sides of the gap 24 are each provided with several isolation grooves 26. The reconstruction components 3 are arranged at the isolation grooves 26, and the reconstruction components 3 are connected to the upper metal layer 21 and the lower metal layer 23 separately.

The reconfigurable coupler based on a ridge gap waveguide can quickly and simply adjust the coupling degree of the coupler according to an on-off state of a PIN diode 34 loaded on the lower metal layer 23 of the ridge gap waveguide 2, such that the coupler has reconfigurable performance, a size of the coupler does not need to be changed, and demands of easy integration and simple machining can be satisfied while a reconfigurable function is achieved.

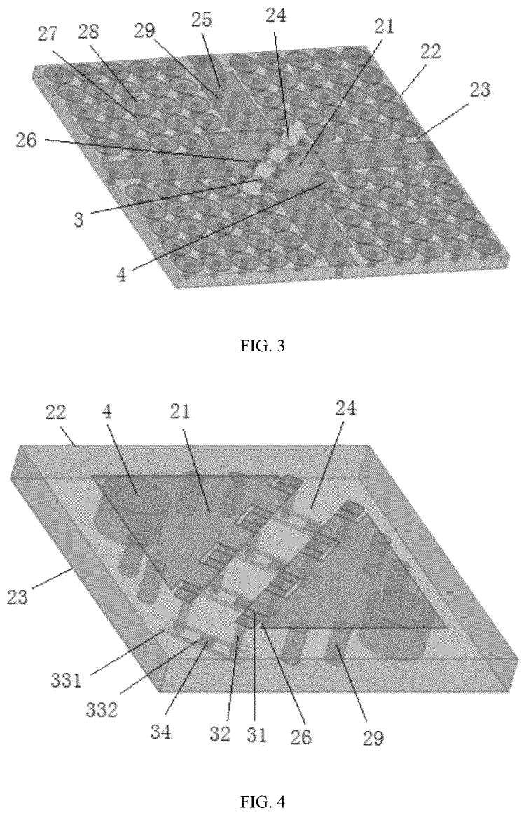

As shown in FIGS. 3 and 4, the reconfiguration component 3 includes a capacitor 31, a metal through hole for reconfiguration 32, a divided-square-shaped groove 33, and the PIN diode 34. The isolation groove 26 is internally provided with the capacitor 31. The lower metal layer 23 is provided with the divided-square-shaped groove 33 and the PIN diode 34. The PIN diode 34 is arranged in the middle of the divided-square-shaped groove 33. Two ends of the PIN diode 34 are connected to the metal through holes for reconfiguration 32 respectively. The metal through holes for reconfiguration 32 are connected to groove walls of the isolation grooves 26 on two sides of the gap 24 by means of the capacitors 31 respectively. The isolation groove 26 is internally connected to the capacitor 31, such that direct currents can be isolated. The second dielectric layer 22 is evenly provided with metal through holes I 27, and a slow-wave effect is introduced, such that an electric field is concentrated in an air cavity 14 of a first dielectric layer 12. Two sides of the gap 24 of the upper metal layer 21 are provided with several metal through holes for reconfiguration 32, which are configured to be connected to the PIN diodes 34 loaded on the lower metal layer 23, and a coupling degree adjustment parameter of the upper metal layer 21, for instance, a distance of the gap 24 of the upper metal layer 21, is converted to the lower metal layer 23. Further, the PIN diodes 34 are loaded on the lower metal layer 23, and the coupling degree of the coupler can be adjusted by controlling the PIN diodes 34 to be switched on and off, such that a reconfigurable function of the coupler based on the ridge gap waveguide 2 is achieved.

The divided-square-shaped groove 33 includes an outer rectangular-ring-shaped groove 331 and an inner strip-shaped groove 332. The inner strip-shaped groove 332 is provided in the outer rectangular-ring-shaped groove 331, and two ends of the inner strip-shaped groove 332 are connected to two sides of the outer rectangular-ring-shaped groove 331 respectively. The PIN diode 34 is arranged in the inner strip-shaped groove 332. The lower metal layer 23 is provided with several divided-square-shaped grooves 33, and rings of outer rings of the divided-square-shaped grooves 33 achieve an isolation function.

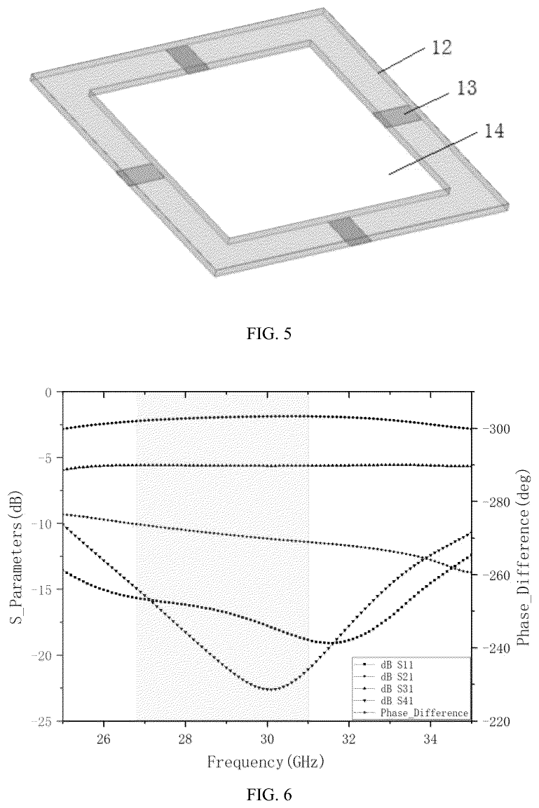

As shown in FIGS. 1 and 5, the inverted microstrip line 1 includes a top metal layer 11, a first dielectric layer 12 having a hollowed middle part and four metal strips 13 distributed on four sides of the first dielectric layer 12 that are arranged from top to bottom. The first dielectric layer 12 is in a square-ring shape larger than the ridge gap waveguide 2. A middle portion of the first dielectric layer 12 is provided with the air cavity 14. The second dielectric layer 22 is provided with several metal through holes I 27. The second dielectric layer 22 is provided with an electromagnetic gap structure periodically arranged, that is, a mushroom-shaped electromagnetic band gap (EBG) structure. The mushroom-shaped EBG structure includes the metal through holes I 27 and circular metal sheets 28. Ends of the metal through holes I 27 are provided with the circular metal sheets 28. The metal through holes I 27 and the circular metal sheets 28 are combined and arranged periodically. Two ends of the mushroom-shaped EBG structure are connected to the air cavity 14 and the lower metal layer 23 respectively. The metal through holes I 27 concentrate most of energy in an air medium of the air cavity 14 of the first dielectric layer 12. The second dielectric layer 12 is provided with several metal through holes II 28. One ends of the metal through holes II 28 are connected to the lower metal layer 23. The other ends of the metal through holes II 28 are connected to the microstrip lines 25 and/or the upper metal layer 21. A dielectric electromagnetic wave of the lower metal layer 23 is pushed to the air cavity 14 at an upper layer. The upper metal layer 21 and the metal strips 13 are arranged on the same level, and the upper metal layer 21 is located in a center of the inverted microstrip line 1.

The reconfigurable coupler based on a ridge gap waveguide has a main structure of a square shape. The first dielectric layer 12 of the inverted microstrip line 1 has a hollowed middle part, and the air cavity 14 is formed in the middle part, such that air is used as a transmission medium, and further dielectric loss is greatly reduced. Lower metal of the inverted microstrip line 1 is feed metal strips 13, and four ports are distributed on four sides of the square shape and extend to a middle coupling feed structure.

As shown in FIGS. 3 and 4, two ends of the diagonal of the upper metal layer 21 are provided with metal through holes for adjustment 4 respectively. Two ends of the metal through holes for adjustment 4 are connected to the upper metal layer 21 and the lower metal layer 23 respectively. The metal through holes for adjustment 4 and the gap 24 are provided at different diagonals of the upper metal layer 21 respectively. The coupling degree can be adjusted through setting of a size of the metal through holes for adjustment 4 and/or a size of the upper metal layer 21, and a distance of the gap 24, and the coupling degree can be adjusted before machining and manufacturing and cannot be modified after machining and manufacturing.

The reconfigurable coupler based on a ridge gap waveguide can adjust the coupling degree of the coupler after machining and manufacturing by controlling the PIN diode 34 to be switched on and off, and a size of the coupler does not need to be changed. A reconfiguration process of the reconfigurable coupler based on a ridge gap waveguide is as follows: the metal through holes for reconfiguration 32 of the reconfiguration components 3 are connected to the upper metal layer 21 and the lower metal layer 23 of the ridge gap waveguide 2 separately, such that a coupling degree adjustment parameter of the distance of the gap 24 of the upper metal layer 21 is converted to the lower metal layer 23; and further the PIN diode 34 loaded on the lower metal layer 23 is controlled to be switched on and off, such that the coupling degree of the coupler is adjusted.

In the reconfigurable coupler based on a ridge gap waveguide, a side length of the upper square metal layer 21 of the ridge gap waveguide 2 and the distance of the gap 24 of the diagonal are determined according to a design index. A size of the metal through holes for adjustment 4 of the ridge gap waveguide 2 is determined according to a design index. Positions and the number of the PIN diodes 34 in the reconfiguration components 3 are determined according to a design index. Positions and the number of the metal through holes for reconfiguration 32 on two sides of the gap 24 of the ridge gap waveguide 2 are determined according to a design index. Positions and a size of the metal through holes I 27 periodically provided of the ridge gap waveguide 2 are determined according to a design index.

A principle of the reconfigurable coupler based on a ridge gap waveguide is described as follows: in order to solve a problem that upper metal of an existing ridge gap waveguide 2 can achieve basic functions of a microstrip line of a coupler but cannot adjust the coupling degree, the reconfigurable coupler based on a ridge gap waveguide provides two metal through holes for adjustment 4 in the lower metal at an end of the diagonal of the upper metal layer 21, and the coupling degree may be adjusted through adjustment of a size of the metal through holes for adjustment 4. The coupling degree can also be adjusted through adjustment of a size of the upper metal layer 21, through which only one coupling degree may be determined and cannot be modified after machining and manufacturing. In the reconfigurable coupler based on a ridge gap waveguide according to the example, several metal through holes for reconfiguration 32 are provided from the upper metal layer 21 to the lower metal layer 23 of the ridge gap waveguide 2, which is equivalent to an operation of converting the coupling degree adjustment parameter of the upper metal layer 21, for instance, converting the distance of the gap 24 of the upper metal layer 21 to the lower metal layer 23. Further, the PIN diode 34 is loaded on the lower metal layer 23, and the coupling degree of the coupler can be adjusted after machining and manufacturing by controlling the PIN diode 34 to be switched on and off. The PIN diode may be controlled to be switched on and off by means of an external bias voltage. The lower metal layer 23 is provided with four divided-square-shaped grooves 33, which causes a risk of energy leakage. However, the metal through holes periodically provided in the mushroom-shaped electromagnetic gap structure, that is, the mushroom-shaped EBG structure, of the ridge gap waveguide 2 concentrate most of energy in the air medium of the air cavity 14 of the first dielectric layer 12. Therefore, leaked energy is ignorable, which is further proved by simulation experiments in FIGS. 6-9.

Through structural design, the reconfigurable coupler based on a ridge gap waveguide has four parameters configured to adjust the coupling degree: the size of the upper metal layer 21 of the ridge gap waveguide 2, the distance of the gap 24, and the size of the metal through holes for adjustment 4, and the on-off state of the PIN diodes 34 of the reconfiguration components 3. The first three parameters are configured to conduct adjustment in a simulation experiment such that the coupler has better coupling degree and isolation degree. A coupling degree may be determined before machining and manufacturing and cannot be modified after machining and manufacturing. The last parameter, that is, the on-off state of the PIN diodes 34 of the reconfiguration components 3, may make the coupler reconfigurable, such that the coupling degree of the coupler can be adjusted after machining and manufacturing, and the size of the coupler does not need to be changed.

The reconfigurable coupler based on a ridge gap waveguide can quickly and simply adjust the coupling degree of the coupler only through switching of the on-off state of the PIN diodes 34 of the reconfiguration components 3 under the condition that the size of the coupler is not changed, such that demands of easy integration and simple machining can be satisfied while the reconfigurable function is achieved. The example may make the coupler based on the ridge gap waveguide 2 reconfigurable under indexes of the coupling degree and the isolation degree, which opens up a new height of coupler design based on the ridge gap waveguide 2.

The reconfigurable coupler based on a ridge gap waveguide according to the example is verified through experimental simulation as follows:

In the reconfigurable coupler based on a ridge gap waveguide according to the example, the first dielectric layer 12 is made of a Rogers 5880 material having a thickness of 0.5 mm, and the first dielectric layer 12 is internally and annularly provided with the air cavity 14 having air. The second dielectric layer 22 is made of a Rogers 3003 material having a thickness of 0.8 mm. The upper metal layer 21 has a side length of 5.8 mm. The gap 24 at the diagonal has a distance of 0.9 mm. The upper metal layer 21 is arranged in parallel with an inner side length of the first dielectric layer 12. The second dielectric layer 22 is provided with the metal through holes I 27. The metal through holes I 27 are provided periodically. The metal through holes I 27 have a radius of 0.2 mm and spacing of 1.7 mm. The metal through holes for reconstruction 32 on two sides of the gap 24 have a radius of 0.1 mm and spacing of 2 mm. The number of the metal through holes for reconstruction 32 and the number of the isolation grooves 26 are both 8. The number of the PIN diodes 34 is four.

Simulation results of the reconfigurable coupler based on a ridge gap waveguide in the example are shown in FIGS. 6-9, which have four states as follows:

FIG. 6 is a schematic diagram of simulation S parameters of a reconfigurable coupler based on a ridge gap waveguide under the condition that 4 PIN diodes 34 are all switched off according to an example. As shown in FIG. 6, the example can achieve 5 dB coupling in a bandwidth from 26.8 GHz to 33 GHz, with a phase difference of 270°+5°.

FIG. 7 is a schematic diagram of simulation S parameters of a reconfigurable coupler based on a ridge gap waveguide under the condition that two PIN diodes 34 in the middle are switched on and two PIN diodes 34 at sides are switched off according to an example. As shown in FIG. 7, the example can achieve 8 dB coupling in a bandwidth from 25 GHz to 31 GHz, with a phase difference of 270°+5°.

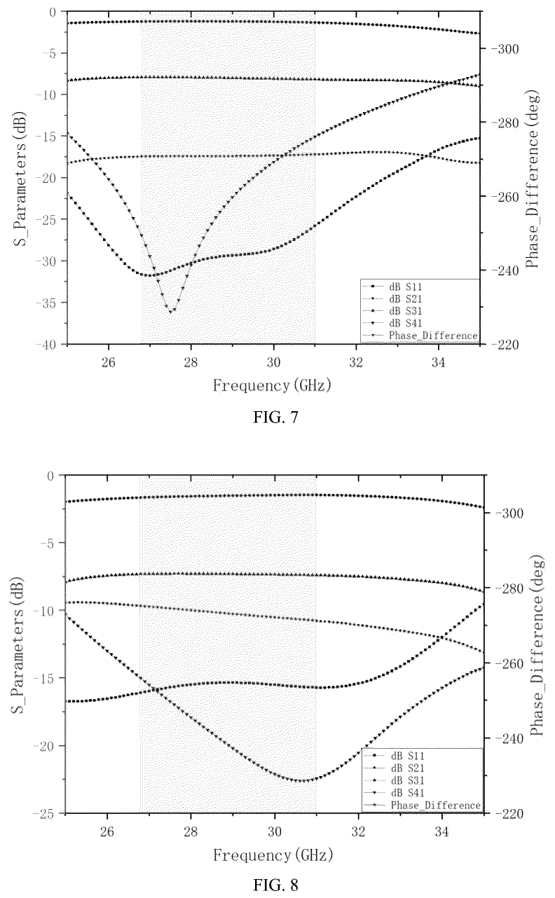

FIG. 8 is a schematic diagram of simulation S parameters of a reconfigurable coupler based on a ridge gap waveguide under the condition that two PIN diodes 34 in the middle are switched off and two PIN diodes 34 at sides are switched on according to an example. As shown in FIG. 8, the example can achieve 7 dB coupling in a bandwidth from 26.8 GHz to 32 GHz, with a phase difference of 270°+5°.

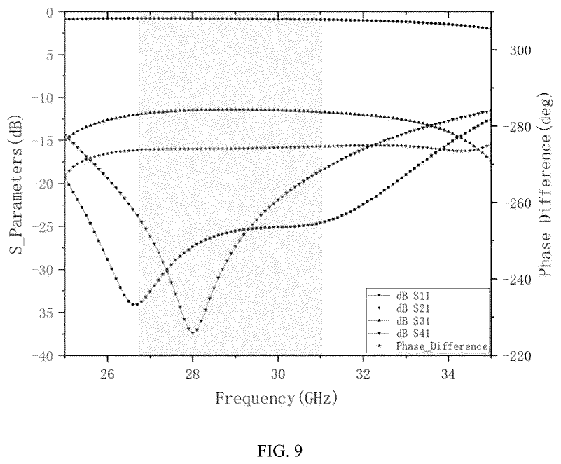

FIG. 9 is a schematic diagram of simulation S parameters of a reconfigurable coupler based on a ridge gap waveguide under the condition that 4 PIN diodes 34 are all switched on according to an example. As shown in FIG. 9, the example can achieve 12 dB coupling in a bandwidth from 26.1 GHz to 32.5 GHZ, with a phase difference of 270°+5°.

To sum up, the reconfigurable coupler based on a ridge gap waveguide in the example can adjust the coupling degree in the bandwidth from 26.8 GHz to 31 GHz.

The above examples only illustrate the technical idea of the present invention, and cannot be used to limit the protection scope of the present invention. Any changes made in the technical solution according to the technical idea put forward by the present invention should fall within the protection scope of the present invention.

What is claimed is:

1. A reconfigurable coupler based on a ridge gap waveguide, comprising:
an inverted microstrip line, a ridge gap waveguide, and several reconfiguration components configured to adjust a coupling degree of a coupler, wherein the inverted microstrip line feeds the ridge gap waveguide with power, the inverted microstrip line is located at an upper layer while the ridge gap waveguide is located at a lower layer, the ridge gap waveguide comprises an upper metal layer, a second dielectric layer and a lower metal layer that are arranged from top to bottom, the upper metal layer is in a square shape having a gap at a diagonal, four sides of the upper metal layer are provided with microstrip lines extending outward to the inverted microstrip line respectively, two sides of the gap are each provided with several isolation grooves, the reconstruction components are arranged at the isolation grooves, and the reconstruction components are connected to the upper metal layer and the lower metal layer separately.

2. The reconfigurable coupler based on a ridge gap waveguide according to claim 1, wherein a reconfiguration component of the reconfiguration components comprises a capacitor, a metal through hole for reconfiguration, a divided-square-shaped groove, and a PIN diode, the isolation groove is internally provided with the capacitor, the lower metal layer is provided with the divided-square-shaped groove and the PIN diode, the PIN diode is arranged in the middle of the divided-square-shaped groove, two ends of the PIN diode are connected to the metal through holes for reconfiguration respectively, and the metal through holes for reconfiguration are connected to groove walls of the isolation grooves on two sides of the gap by means of the capacitors respectively.

3. The reconfigurable coupler based on a ridge gap waveguide according to claim 2, wherein the divided-square-shaped groove comprises an outer rectangular-ring-shaped groove and an inner strip-shaped groove, the inner strip-shaped groove is provided in the outer rectangular-ring-shaped groove, two ends of the inner strip-shaped groove are connected to two sides of the outer rectangular-ring-shaped groove respectively, and the PIN diode is arranged in the inner strip-shaped groove.

4. The reconfigurable coupler based on a ridge gap waveguide according to claim 1, wherein the inverted microstrip line comprises a top metal layer, a first dielectric layer having a hollowed middle part and four metal strips distributed on four sides of the first dielectric layer that are arranged from top to bottom, the first dielectric layer is in a square-ring shape larger than the ridge gap waveguide, and a middle portion of the first dielectric layer is provided with an air cavity.

5. The reconfigurable coupler based on a ridge gap waveguide according to claim 4, wherein the second dielectric layer is provided with a mushroom-shaped electromagnetic band gap (EBG) structure periodically arranged, the mushroom-shaped EBG structure comprises metal through holes I and circular metal sheets, ends of the metal through holes I are provided with the circular metal sheets, and the metal through holes I and the circular metal sheets are combined and arranged periodically, and two ends of the mushroom-shaped EBG structure are connected to the air cavity and the lower metal layer respectively.

6. The reconfigurable coupler based on a ridge gap waveguide according to claim 4, wherein the upper metal layer and the metal strips are arranged on the same level, and the upper metal layer is located in a center of the inverted microstrip line.

7. The reconfigurable coupler based on a ridge gap waveguide according to claim 6, wherein the second dielectric layer is provided with several metal through holes II, one ends of the metal through holes II are connected to the lower metal layer, and the other ends of the metal through holes II are connected to the microstrip lines and/or the upper metal layer.

8. The reconfigurable coupler based on a ridge gap waveguide according to claim 7, wherein two ends of the diagonal of the upper metal layer are provided with metal through holes for adjustment respectively, two ends of the metal through holes for adjustment are connected to the upper metal layer and the lower metal layer respectively, and the metal through holes for adjustment and the gap are provided at different diagonals of the upper metal layer respectively.

9. The reconfigurable coupler based on a ridge gap waveguide according to claim 2, wherein the reconfigurable coupler based on a ridge gap waveguide adjusts the coupling degree before machining and manufacturing through setting of a size of the metal through holes for adjustment and/or a size of the upper metal layer, and a distance of the gap.

10. The reconfigurable coupler based on a ridge gap waveguide according to claim 1, wherein a reconfiguration process of the reconfigurable coupler based on a ridge gap waveguide is as follows: the metal through holes for reconfiguration of the reconfiguration components are connected to the upper metal layer and the lower metal layer of the ridge gap waveguide separately, such that a coupling degree adjustment parameter of a distance of the gap of the upper metal layer is converted to the lower metal layer; and further the PIN diode loaded on the lower metal layer is controlled to be switched on and off, such that the coupling degree of the coupler is adjusted after machining and manufacturing.

11. The reconfigurable coupler based on a ridge gap waveguide according to claim 3, wherein the reconfigurable coupler based on a ridge gap waveguide adjusts the coupling degree before machining and manufacturing through setting of a size of the metal through holes for adjustment and/or a size of the upper metal layer, and a distance of the gap.

12. The reconfigurable coupler based on a ridge gap waveguide according to claim 2, wherein a reconfiguration process of the reconfigurable coupler based on a ridge gap waveguide is as follows: the metal through holes for reconfiguration of the reconfiguration components are connected to the upper metal layer and the lower metal layer of the ridge gap waveguide separately, such that a coupling degree adjustment parameter of a distance of the gap of the upper metal layer is converted to the lower metal layer; and further the PIN diode loaded on the lower metal layer is controlled to be switched on and off, such that the coupling degree of the coupler is adjusted after machining and manufacturing.

13. The reconfigurable coupler based on a ridge gap waveguide according to claim 3, wherein a reconfiguration process of the reconfigurable coupler based on a ridge gap waveguide is as follows: the metal through holes for reconfiguration of the reconfiguration components are connected to the upper metal layer and the lower metal layer of the ridge gap waveguide separately, such that a coupling degree adjustment parameter of a distance of the gap of the upper metal layer is converted to the lower metal layer; and further the PIN diode loaded on the lower metal layer is controlled to be switched on and off, such that the coupling degree of the coupler is adjusted after machining and manufacturing.

14. The reconfigurable coupler based on a ridge gap waveguide according to claim 4, wherein a reconfiguration process of the reconfigurable coupler based on a ridge gap waveguide is as follows: the metal through holes for reconfiguration of the reconfiguration components are connected to the upper metal layer and the lower metal layer of the ridge gap waveguide separately, such that a coupling degree adjustment parameter of a distance of the gap of the upper metal layer is converted to the lower metal layer; and further the PIN diode loaded on the lower metal layer is controlled to be switched on and off, such that the coupling degree of the coupler is adjusted after machining and manufacturing.

15. The reconfigurable coupler based on a ridge gap waveguide according to claim 5, wherein a reconfiguration process of the reconfigurable coupler based on a ridge gap waveguide is as follows: the metal through holes for reconfiguration of the reconfiguration components are connected to the upper metal layer and the lower metal layer of the ridge gap waveguide separately, such that a coupling degree adjustment parameter of a distance of the gap of the upper metal layer is converted to the lower metal layer; and further the PIN diode loaded on the lower metal layer is controlled to be switched on and off, such that the coupling degree of the coupler is adjusted after machining and manufacturing.
